(19) United States
(12) Patent Application Publication
(10) Pub. No.: US 2022/0291398 A1
(43) Pub. Date: Sep. 15, 2022

(54) Distributed Radiation Monitoring Systems and Methods

(71) Applicant: AL Ventures, LLC, Austin, TX (US)

(72) Inventor: Alex Edward Athey, Austin, TX (US)

(73) Assignee: AL Ventures, LLC, Austin, TX (US)

(21) Appl. No.: 17/201,644

(22) Filed: Mar. 15, 2021

(51) Int. Cl. G01T 1/167; G01T 1/169; G01T 1/20

(52) U.S. Cl. CPC G01T 1/167; G01T 1/169; G01T 1/20

(57) ABSTRACT

A radiation sensor device may include at least one radiation sensor configured to capture radiation measurement data, a location circuit to determine physical location data, a clock to provide timestamp data, and one or more communication interfaces configured to communicate with a radiation mapping system through one or more of a communication network or a communications link. The device may include a processor configured to selectively control a frequency of operation of the one or more sensors to capture the radiation measurement data based on changes to the physical location data. The device may be configured to correlate the radiation measurement data to the physical location data and the timestamp and to determine an anomalous radiation measurement based on the radiation measurement data relative to background radiation data. The device may send an alert to the radiation mapping system in response to determining the anomalous radiation measurement.

### FIELD

The present disclosure is generally related to radiation detection and monitoring systems, and more particularly, to systems and methods that include portable, distributed radiation sensor devices that may enable wide-area surveillance for the presence or movement of anomalous radiation sources.

### BACKGROUND

Wide-area radiation surveillance represents a significant challenge for environmental and security applications. A wide area, such as a school campus, a business campus, a sports venue, a city, a county, or another defined area, may be very expensive to monitor over time, particularly using fixed sensor devices. Such surveillance may be too expensive for most cities to undertake. Current surveys require dedicated campaigns and highly trained professionals to produce onetime assessments.

The Centers for Disease Control and Prevention (CDC) defines radiation as energy that comes from a source and that travels through space at the speed of light. Such energy has an electric field and a magnetic field associated with it and exhibits wave-like properties. Radioactive substances can emit different types of radiation, including alpha particles, beta particles, gamma rays, and neutrons, which may be detected using different types of detectors.

### SUMMARY

Embodiments of systems, methods, and sensor devices are described herein that may be configured to capture radiation measurements and associated location and timestamp data. The sensor devices may be configured to attach to vehicles, such as municipal service vehicles (e.g., garbage trucks, post office carrier vehicles, firetrucks, ambulances, police cars, security vehicles, other vehicles, or any combination thereof). Each sensor device may capture radiation measurement data and location data as the vehicle to which it is attached moves. The sensor devices may include a circuit including a radiation sensor to capture radiation measurement data, a non-volatile memory to store the measurement data, and communication circuitry configured to send the measurement data to a server when the vehicle is parked in a municipal depot. In some implementations, in addition to sending the measurement data when the vehicle is parked, the sensor devices may communicate the measurement data periodically, according to a pre-determined schedule, or when the vehicle is at or near a pre-defined location or may send periodic signals indicating that the sensor device is operating and has not detected an anomalous radiation measurement or may send an alert in response to detecting an anomalous radiation measurement.

In some implementations, each sensor device may communicate the measurement data to a computer server through a short-range wireless communications link, a wide-area network, a satellite or cellular network, or any combination thereof or through another communications path. The server may process received data to determine if any anomalous radiation measurements were captured relative to background radiation data. Additionally, the received data may be used to update the background radiation data.

In some implementations, each radiation sensor device may include a processor configured to determine anomalous radiation measurement relative to expected background radiation. In an example, the processor may be configured to compare radiation sensor measurement data to background radiation data to determine a difference. When the difference exceeds a threshold, the radiation sensor device may communicate an alert to one or more computing devices through a communications network. An alert may include radiation measurement data, location data, timestamp data, and other data, such as information about the alert and instructions for responding. In some implementations, the processor may compare spectral data from the measurements to background spectral data to determine a difference. Thresholds may vary between the various spectra to reduce or eliminate false positives. Other implementations are also possible.

In some implementations, a radiation sensor device may include at least one radiation sensor configured to capture radiation measurement data, a physical location circuit (such as a global positioning satellite (GPS) circuit) to determine physical location data, a clock to provide timestamp data, and one or more communication interfaces configured to communicate with one or more computing devices through a communication network. The radiation sensor device may also include a processor configured to selectively control a frequency of operation of the one or more sensors to capture the radiation measurement data based on changes to the physical location data. In one example, a radiation sensor device may monitor position data from the physical location circuit and may begin capturing measurements once the physical location of the radiation sensor device is within an assigned geophysical area. In another example, the radiation sensor device may capture radiation measurements according to a first interval when the radiation sensor device is moving at a first velocity, a second interval when the radiation sensor device is moving at a second velocity, and so on. In some instances, the radiation sensor device may capture radiation measurements at five-minute intervals when the radiation sensor device is not moving. Other intervals and other frequency variations are also possible. The radiation sensor device may be configured to correlate the radiation measurement data to the physical location data and the timestamp, determine an anomalous radiation measurement when the radiation measurement data exceeds a threshold; and in response to determining an anomalous radiation measurement, send an alert one or more computing devices through the communications network.

In some implementations, such as in an arena or other known area, the position location technology may include a wireless transceiver, an optical sensor, motion sensors, or any combination thereof. In such an example, the position or location of the device may be determined based on one or more of radio frequency data, optical data, or motion data.

The device may include a non-volatile memory storing data including one or more of threshold data or background radiation measurement data and storing processor-readable instructions. The device may include a processor coupled to the one or more communications interfaces, the one or more radiation sensors, the position location circuit, and the non-volatile memory. The processor may be configured to selectively control timing of measurements by the one or more radiation sensors, correlate the radiation measurement data to the physical location data and the timestamp data, and determine one or more of a sensor error or a radiation event based on the radiation measurement data. The processor may be configured to send an alert or status message to the one or more computing devices in response to determining the one or more of the sensor error or the radiation event. The alert may include one or more of a small message system text message, an email message, an audio message, or a web page including information related to the sensor error or the radiation event.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a block diagram of a radiation monitoring system including a plurality of radiation measurement devices, in accordance with certain embodiments of the present disclosure.

FIG. 2 depicts a block diagram of a radiation sensor device of the radiation monitoring system of FIG. 1, in accordance with certain embodiments of the present disclosure.

FIG. 3 depicts a block diagram of a computing device that may communicate with the radiation monitoring system of FIG. 1, in accordance with certain embodiments of the present disclosure.

FIG. 4 depicts a flow diagram of a method of providing captured radiation data to a server system, in accordance with certain embodiments of the present disclosure.

FIG. 5 depicts a flow diagram of a method of calibrating a radiation sensor device based on background measurement data, in accordance with certain embodiments of the present disclosure.

FIG. 6 depicts a flow diagram of a method of generating an alert in response to detecting a radiation measurement that exceeds a threshold, in accordance with certain embodiments of the present disclosure.

FIG. 7 depicts a graphical interface including user-selectable controls to access radiation data, simulation data, and sensor status data, in accordance with certain embodiments of the present disclosure.

FIG. 8 depicts a graphical interface including user-selectable controls and including radiation measurement data, in accordance with certain embodiments of the present disclosure.

FIG. 9 depicts a graphical interface including user-selectable controls and including simulation data, in accordance with certain embodiments of the present disclosure.

FIG. 10 depicts a graphical interface including user-selectable controls and including radiation sensor data, in accordance with certain embodiments of the present disclosure.

While implementations are described in this disclosure by way of example, those skilled in the art will recognize that the implementations are not limited to the examples or figures described. The figures and detailed description thereto are not intended to limit implementations to the particular form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the work “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

For security, environmental, or regulatory purposes, it may be desirable to monitor specified areas for unexpected changes in radioactivity. Described herein are systems and methods for detecting anomalous radiation measurements that may make use of stationary sensors as well as sensors coupled to vehicles to capture radiation measurements over a selected area, such as a city, a county, a campus, an arena, or another defined area.

In some implementations, the systems and methods may utilize multiple radiation sensor devices to collect radiation measurements in the selected area. To accurately detect anomalous radiation measurements, a background radiation or baseline may be determined from radiation measurement data captured over a period of time. Over the period of time, a vector of radiation counts may be determined for each location and time by summing one or more of the radiation measurement records. The radiation sensor data of each sensor devices may be correlated to timestamps and to geospatial locations, and the data may be aggregated with data from others of the multiple radiation sensor devices to build a spatial-spectral map of background radiation levels over time for the selected area. In some implementations, the radiation sensor devices may be configured to measure ambient radiation levels, which may be reported in International Units, such as Grey per hour (Gy/h) or Sievert per hour (Sv/h), or in U.S. Units, such as Roentgen per hour (R/h) or rem per hour (rem/h). The radiation measurement data may include radiation counts for multiple radiation sources of different types of radiation, which may be reflected in radiation spectral data.

Each of the radiation sensor devices may be used to perform multi-pass radiation surveys in the selected area, for example, as the vehicle traverses various roadways. In some implementations, each radiation sensor device may perform radiation anomaly detection by comparing captured radiation measurement data to a background radiation measurement for the same location. The background radiation measurement data may be calculated from a plurality of radiation measurements for each location that were previously collected by one or more of the radiation sensor devices. In some implementations, this background radiation measurement calculation may determine appropriate thresholds for variance deviation in the background radiation spectra that will be both location and spectra dependent.

In some implementations, the radiation measurement data may be collected by a plurality of sensor devices, and the measurement data may be provided to a computing device, such as a computer server, which may process the measurement data and associated location data to assemble the background radiation measurement data. Periodically, the server may communicate the background radiation measurement data to the radiation sensor devices, and the background data may be used to determine anomalous new radiation measurements.

In general, with respect to radiation measurement data, spatial variance is larger than temporal variance within the radiation measurement data, and this fact enables the systems and methods to be sensitive to anomalies by capturing and characterizing radiation measurement data for an area over a period of time, e.g., days, weeks, months, years, etc. The accumulated measurement data may be aggregated to produce background radiation measurement data. In some implementations, the systems and methods may be configured to detect anomalous radiation measurements based on a spectral distribution of the measurement data relative to the spectral distribution of background radiation measurement data, enabling anomalous radiation detection with limited or different amounts of background radiation data. Using the spectral distribution may allow the system to detect small changes in spectral distribution over time, even with limited background data.

In some implementations, the spectral-spatial distribution data may enable a selected granularity with respect to comparisons between radiation measurement data and background radiation data, enabling detection of variations with respect to particular types of radiation sources and enabling thresholds that may be source specific, location specific, targeted (for example, based on a specific threat or based on information), or any combination thereof. In an example, application of fertilizer (including potassium and other minerals) on an athletic field may register in the radiation measurement data, producing a change in the amplitude of the measurement data at one or more frequencies. Over a few days or weeks, the influence of the fertilizer on the radiation measurements may decrease over the course of a few days or weeks and may increase again when fertilizer is reapplied. Since fertilizer may be applied periodically, it may be desirable to provide different thresholds for different spectra within the spectral data, so that radiation measurement variations due to the fertilizer applications are not reported as anomalous. Such variations may be specific to a particular area.

In some implementations, a selected area can be divided into sections or grids, for example, based on any number of physical parameters (streets, geographically defined areas (e.g., parks, communities, etc.), campuses, etc.), measurement parameters (e.g., areas that have consistent radiation measurements or common measurement characteristics (e.g., measurements that vary widely for one or more frequency spectra, such as with the fertilizer example)), or any combination thereof. Different thresholds may be established for each of the sections or grids.

In some implementations, the radiation sensor device may include one or more radiation sensors configured to capture radiation measurement data, periodically (at a selected frequency), spatially (at a selected spacing, such that a measurement is captured each time the radiation sensor device is moved by a selected distance), or any combination thereof. The timer of the radiation sensor device may be used to maintain the measurement frequency and to create a timestamp for each measurement, and a physical location circuit (such as a GPS circuit or other location circuit, may provide geospatial location data. The radiation sensor device may correlate the radiation measurement data with the timestamp and the location data and may store the correlated data in a local, non-volatile memory. In some implementations, the radiation sensor device may include communication circuitry (such as a transceiver or a transmitter) configured to communicate with one or more computing devices through a short-range wireless communications link (such as Bluetooth or a local area network or another network, such as a citizen's band (CB) radio signal or another mobile radio system) or through a wide area communications network, such as a cellular network, a digital network, the Internet, or any combination thereof. In an example, the radiation sensor device may communicate with a radiation mapping system (which may be implemented as a computer server accessible via a network connection) to communicate one or more of the correlated radiation measurement data or an alert.

In some implementations, the correlated radiation measurement data may be used to determine a difference between the sensor measurement data and background radiation data, such as by comparing spectral data to background spectral data. The difference may then compare the difference (in a selected spectra) to a threshold (associated with the spectra) to determine an anomaly or radiation event, when the difference exceeds a threshold. Determination of an anomaly may cause one or more of a server system or the radiation sensor device to generate one or more alerts. An alert may include an SMS (short message service) text message, a phone call, an email message, an audio alert, a visual alert, another type of alert, or any combination thereof. The alert may include information about the radiation measurement data that triggered the alert including the location and date and time of the measurement as well as information about the content of the radiation measurement data (such as the type of radiation, the amplitude of the difference between the radiation measurement data and the background radiation measurement data, and so on). The alert may also include information indicating who the alert was sent to as well as instructions for responding to the alert. The determination of an anomaly and the generation of the alert may be performed by one or more of the radiation sensor device or the radiation mapping system. Other implementations are also possible.

In some implementations, the radiation mapping system may divide a selected area into a plurality of cells or subdivisions. The background radiation measurement for each cell or subdivision may be determined based on previously captured radiation measurements associated with the cell or subdivision. In an example, a cell may be rectangle, square, circle, polygon, or another geometric shape (or combination of shapes), which may correspond to a selected area. In some implementations, a cell or subdivision may represent a selected area in selected units squared, such as 250 square meters, N square yards, and so on. In another example, the cell or subdivision may be selected using streets as boundaries, and the selected area may be defined in terms of streets. In yet another example, the cell or subdivision may be selected based on a commonality of previously collected radiation measurement data or radiation measurement variation and may evolve and further subdivide over time as more data is collected. Other cell sizes or subdivision sizes and other bases for selection or division of an area into cells or subdivisions are also possible.

In some implementations, the radiation mapping system or the radiation sensor device may be configured to utilize spectral analysis to compare spectral content of the radiation measurement and spectral content of the background radiation measurement to determine a difference. If the spectral difference exceeds a threshold for at a particular frequency, the system may determine an anomalous radiation measurement, which may trigger generation of one or more alerts. In an example, the radiation mapping system may divide the energy spectrum into a plurality of energy segments or channels with a corresponding plurality of thresholds. The energy segments or channels may be distributed evenly across the energy spectrum, selectively to cover targeted spectral segments, in a targeted manner to cover selected spectra, in a targeted manner to detect targeted isotopes, or any combination thereof.

In some implementations, the system may determine an anomalous radiation measurement when a difference between the spectral content of the radiation measurement and the spectral content of the background radiation measurement differs from an expected variation in the background radiation measurement by more than a threshold amount. For example, if the difference indicates that the spectral content of the radiation measurement is below that of the background radiation measurement by more than a threshold amount, the radiation sensor may need to be checked, causing an alert to be generating that is indicative of a radiation sensor device to be serviced. If the spectral content of the radiation measurement is above that of the background radiation measurement by more than a threshold amount, a radiation event may be determined, which may trigger generation of one or more alerts. In other implementations, the nature of the correlation in the spatial distribution of the anomalous readings may be used to infer certain aspects of the anomalous detection such as distinguishing the difference between a small source nearby and a large source far away, which currently is not possible with conventional radiation measurement systems.

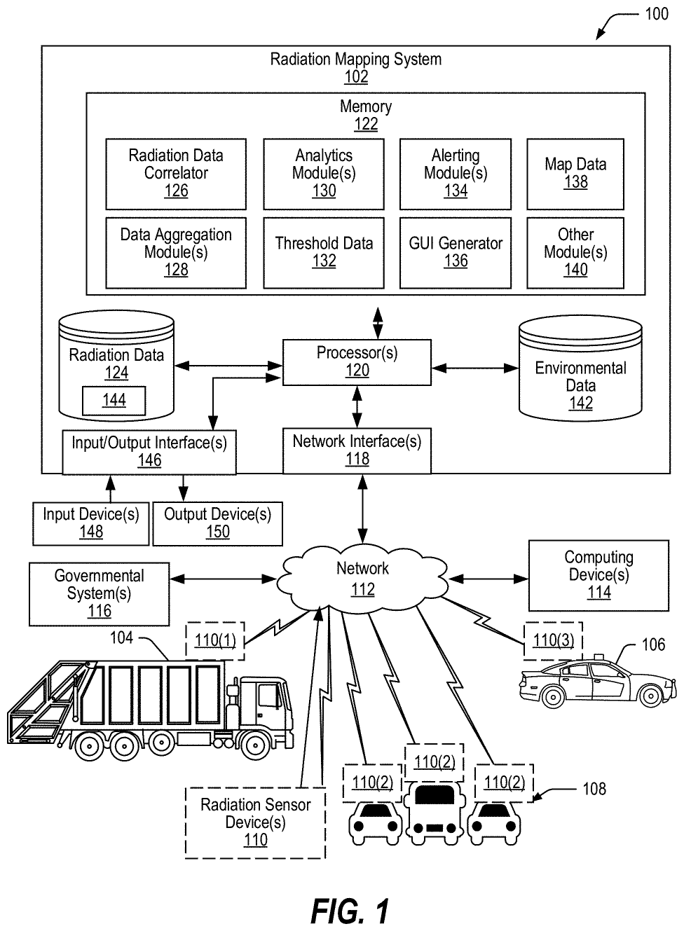

Embodiments of the systems, methods and devices described below may include a plurality of radiation sensor devices, which may be distributed within a selected area. The radiation sensor devices may be distributed or deployed on vehicles or installed on structures and may be configured to capture radiation measurements and associated timestamp and location data throughout the selected area. The radiation sensor devices may provide the captured radiation measurement data to a radiation mapping (monitoring) system, which may process the radiation measurement data to determine background radiation measurement data and to determine anomalies or radiation events. In some implementations, the radiation mapping system may produce one or more visualizations of the radiation measurement data, which may be presented within a graphical interface on a computing device, such as within an Internet browser interface. Such visualizations may include a map of a geographic area including a visual indicator of radiation measurement data distributed on the map. An example of a radiation monitoring system is described below with respect to FIG. 1.

FIG. 1 depicts a block diagram of a radiation mapping (monitoring) system 100, in accordance with certain embodiments of the present disclosure. The system 100 may include a radiation mapping system 102, which may be configured to communicate with one or more radiation sensor devices 110, one or more computing devices 114, and one or more governmental systems 116 through a communications network 112. The computing devices 114 may include smartphones, tablet computers, laptop computers, desktop computers, in-vehicle computing systems, other computer devices, or any combination thereof. The governmental systems 116 may include computing systems associated with law enforcement agencies, the United States Department of Homeland Security, the Federal Bureau of Investigation (FBI), the United States Department of Energy, other governmental agencies, or any combination thereof. The communications network 112 may include short-range wireless networks (such as Bluetooth® communications links, local area networks, vehicular networks, and the like), proprietary networks, wide-area networks (such as the Internet, cellular communications networks, satellite communications networks, and the like), or any combination thereof. In some implementations, the communications network 112 may include a citizen's band (CB) radio frequency network through which data may be sent and received.

In some implementations, the radiation sensor devices 110 may communicate with a computing system that is associated with a vehicle, and the computing system of the vehicle may communicate data to or receive data from the radiation mapping system 102, from a location circuit (such as a global positioning satellite (GPS) circuit), from other systems, or any combination thereof. Alternatively, the radiation sensor devices 110 may include one or more communication circuits configured to communicate with the radiation mapping system 102 through the network 112.

One or more of the radiation sensor devices 110 may be standalone devices, which may be coupled to a building, a streetlamp, a traffic light, a statue, a walking light, another structure, or any combination thereof. Such standalone devices may be coupled to a power supply, such as a solar cell, a wired electrical supply, or any combination thereof. Standalone devices may be deployed to cover choke points during special events or mass gatherings and may be collected afterward. In some implementations, such standalone devices may be reused or redeployed for other special events or mass gatherings.

One or more of the radiation sensor devices 110 may be coupled to a vehicle. For example, a radiation sensor device 110(1) may be coupled to a garbage truck 104. A radiation sensor device 110(3) may be coupled to a police car 106. Radiation devices 110(2) may be coupled to municipal fleet vehicles, generally indicated at 108. In some implementations, the radiation sensor devices 110 may be deployed on various vehicles that routinely travel within a selected area. Such vehicles can include police cars 106, garbage trucks 104, firetrucks, other municipal vehicles 108, post office carrier vehicles, firetrucks, ambulances, security vehicles, other vehicles, or any combination thereof. In some instances, the radiation sensor devices 110 may be deployed on golf carts or other vehicles that may be used to transport security or other personnel around a facility, such as a stadium, a park, or another area.

Each of the radiation sensor devices 110 may include a radiation sensor configured to generate electrical signals indicative of trace radiation. In an illustrative, non-limiting example, the radiation sensor may be implemented as a scintillation detector, such as a Cesium Iodide scintillation detector, a gamma ray detector, a neutron detector, other detectors, or any combination thereof. Each radiation sensor device 110 may also include a processor, a geophysical location circuit (such as a GPS circuit), a clock, and other circuitry. In some implementations, the geophysical location circuit may be omitted, and the radiation sensor device 110 may receive location data from circuitry associated with the vehicle.

The processor may be configured to receive the signals from the radiation sensor and to determine radiation measurement data (such as raw counts, radiation spectra (e.g., counts with associated energy levels and associated frequency spectra), other data, or any combination thereof based on the received signals) and to correlate the determined radiation measurement data to timestamp data from the clock and to location data from the location circuit or from the vehicle. In some implementations, the radiation measurement device may also include a temperature sensor, which may be used to compensate for temperature-related drift in the radiation measurement data. Each of the radiation sensor devices 110 may be configured to capture radiation measurement data, an associated timestamp, and associated geospatial location data for each measurement, to correlate the radiation measurement data with the time stamp and location data, and to store the correlated measurement data in a non-volatile memory. The radiation sensor devices 110 may be configured to capture measurement data periodically (such as every 500 milliseconds or at other time intervals), at regular distance intervals (such as every 0.05 miles, or some other distance interval), at selected locations, or any combination thereof.

In some implementations, each of the radiation sensor devices 110 may be configured to selectively control a frequency of operation of the one or more sensors to capture the radiation measurement data based on changes to the physical location data. For example, the radiation sensor device 110 may be configured to capture radiation measurement data periodically or whenever the vehicle travels a certain distance (based on a speed of the vehicle). In an example, the radiation sensor device 110 may capture radiation measurements at a frequency of approximately one Hertz (once per second). In another example, the radiation sensor device 110 may capture a radiation measurement each time the vehicle travels approximately 50 meters (or another distance), which may be determined using the changes in the physical location over time. Other implementations are also possible.

Each of the radiation sensor devices 110 may include a transceiver configured to communicate the correlated measurement data to the radiation mapping system 102 through the network 112 or to an in-vehicle computing system, which may send the correlated measurement data to the radiation mapping system 102. In some implementations, the in-vehicle computing system may receive the correlated measurement data from the radiation sensor device 110 and may communicate the data via a proprietary network or another communications link to the radiation mapping system 102.

The radiation sensor devices 110 may communicate the correlated measurement data when the vehicle (e.g., garbage truck 104, police car 106, fleet vehicle 108, or other vehicle) is returned to a “home” location, such as a fleet parking lot or municipal depot. In some implementations, the radiation sensor devices 110 may communicate the correlated measurement data according to a pre-determined schedule or in response to detecting a radiation event (e.g., when a radiation sensor measurement exceeds a background radiation level by more than a threshold amount for a selected frequency spectra or across a range of spectra). In another implementation, the radiation sensor devices 110 may communicate the correlated measurement data in response to a request from the radiation mapping system 102. Other data communication schedules or events are also possible.

The radiation mapping system 102 may be a computing device, such as a computer server configured to store data, execute processor-readable instructions, and send and receive data through the communications network 112. In some implementations, the radiation mapping system 102 may present a graphical interface (such as a webpage) that may be accessed by a computing device 114 to view one or more visualizations of the radiation measurement data, such as radiation map data and other data related to the radiation measurements. The radiation mapping system 102 may be configured to analyze the received correlated measurement data and to selectively send alerts to one or more of the government systems 118, the computing devices 114, or the vehicles 104, 106, or 108.

The radiation mapping system 102 may include one or more network interfaces 118, which may communicate with the network 112. The one or more network interfaces 118 may include multiple transceivers, including satellite, cellular, Bluetooth, other short-range wireless (e.g., IEEE 802.11x), local area network, proprietary, or any combination thereof.

The radiation mapping system 102 may include one or more processors 120 coupled to the network interfaces 118. The radiation mapping system 102 may also include a memory 122 coupled to the one or more processors 120. The memory 122 may store data and processor-readable instructions that may cause the processor 120 to determine anomalous radiation events from the radiation measurement data received from one or more radiation sensor devices 110.

The radiation mapping system 102 may include radiation data 124 and environmental data 142 (such as temperature, humidity, and other environmental parameters), which may be stored in one or more databases. The radiation data 124 and the environmental data 142 are depicted as being external to the memory 122, but may be stored in the memory 122, in a separate memory, or externally (accessible through a wired connection, a wireless connection, or through the network 112. In some implementations, the radiation data 124 and the environmental data 142 may be combined in a single database. The memory 122 may include a non-volatile memory, such as a hard disc drive, a flash memory device, another non-volatile memory device, or any combination thereof.

The memory 122 may include a radiation data correlator 126 that, when executed, may cause the processor 120 to receive data from one or more of the radiation sensor devices 110, to determine location data from the received data, and to retrieve background radiation data from the radiation data 124 corresponding to the location data. In some implementations, the radiation data correlator 126 may extract location data from the received correlated radiation measurement data and may retrieve background radiation measurement data from the radiation data 124. In some implementations, some of the radiation sensor devices 110 may send raw radiation measurement data, location data, time data, and environmental data to the radiation mapping system 102 may correlate the raw radiation measurement with the associated timestamp and location data for storage in the radiation data 124. In some implementations, in addition to correlating the radiation data to the timestamp and location data, the radiation data correlator 126 may cause the processor 120 to correlate the radiation measurement data to environmental condition data, such as temperature, humidity, and other environmental data.

The memory 122 may include one or more data aggregation modules 128 that, when executed, may cause the processor 120 to combine the received radiation measurement data with radiation data 124 to produce background radiation measurement data 144. In some implementations, the received radiation measurement data may be added to the background radiation measurement data 144 to update the background radiation measurement data. In some implementations, the aggregate background radiation may be divided by a number of measurement samples that were added to produce the aggregate background radiation to produce an average background radiation value. By utilizing newly received radiation measurement data to update the background radiation measurement data 144, the background radiation measurement data 144 may become increasingly accurate over time and may provide for monitoring of long-term trends. Other implementations are also possible.

The memory 122 may include one or more analytics modules 130 that, when executed, may cause the processor 120 to compare the received radiation measurement data to the radiation background measurement data to determine a difference. The analytics modules 130 may cause the processor to compare the difference to one or more thresholds from the threshold data 132. The threshold data 132 may include a threshold that is common across a selected area, multiple thresholds that may correspond to different sub-areas of the selected area, individual area thresholds defined from previously observed variances, and so on. In an example, the threshold data 132 may include a plurality of thresholds, each of which may correspond to a spectral frequency, enabling detection of variations within the spectral data.

When the difference exceeds a selected threshold, the analytics module 130 may cause the processor 120 to execute one or more alerting modules 134, which may selectively send one or more alerts through the network 112 to one or more of the governmental systems 116, the computing devices 114, or vehicles systems within one or more of the garbage trucks 104, the police cars 106, the fleet vehicles 108, or other vehicles. In some implementations, the alerting module 134 may cause send the alert to the vehicle system, which may communicate the alert to the radiation mapping system 102. In other implementations, when the radiation measurement data is less than the background radiation data, the radiation measurement data may be indicative of a problem with the radiation sensor device 110 (which may require service), since the background radiation data is relatively constant and should measure consistently over time for a given location.

In some implementations, the threshold data 132 may include multiple thresholds for each location. The analytics module 130 may cause the processor 120 to compare the difference between the received radiation measurement data and the background measurement data for a location to each of the thresholds for the location. If the difference is greater than a first threshold and less than a second threshold, the alerting module 134 may send an alert to a computing device 114 associated with an administrator of the radiation mapping system 102 to review for data errors. If the difference is greater than the first and second thresholds and less than a third threshold, the alerting module 134 may send an alert to one or more of the vehicles, such as a police car 106, a fleet vehicle 108, or the vehicle associated with the anomalous measurement data to revisit the location to capture new radiation measurement data. If the difference exceeds the first and second thresholds and exceeds a third threshold or if a difference between the new radiation measurement data and the background radiation measurement data exceeds the first and second thresholds, the alerting module 134 may send an alert to the one or more government systems 116.

While the above-discussion assumes that the radiation measurement data is first compared to the background radiation data to determine a difference, which is then compared to a threshold, other implementations are also possible. In an example, the threshold may represent a value that includes a background radiation value and optionally a difference value to which the radiation measurement data may be compared directly to determine an anomalous measurement or event. In another example, a radiation event or anomaly may be determined when a radiation measurement exceeds a threshold value, which may be consistent for a pre-determined area. Over time, a threshold value may be determined relative to a consistent radiation background level. In some instances, such a threshold value may be used to accurately detect a radiation anomaly or event in a number of different areas. In some implementations, the computing device 114 can be preloaded with alert levels, which may be stored in memory 122 and which may be determined by one or more of the methods described above. Other implementations are also possible.

In some implementations, the memory 122 may include a graphical user interface (GUI) generator 136 that, when executed, may cause the processor 120 to generate a graphical interface, which may be sent through the network 112 to one or more computing devices 114. The graphical interface may include data as well as user-selectable controls accessible by a user to select data, alter visualizations, trigger alerts, send electronic messages, and so on. The memory 122 may include map data 138 that may be provided to the GUI generator 136 to enable presentation of radiation measurement data on maps, such as a map of a city or other selected area. In some implementations, the graphical interface may include a web page that may be provided to an Internet browser application of a computing device 114. The memory 122 may also include one or more other modules 140 that may be executed by the processor 120 to provide various functions. In some implementations, the presentation of the radiation data may be provided to command centers for Government systems 116.

In some implementations, the radiation mapping system 102 may include one or more input/output (I/O) interfaces 146, which may be coupled to the one or more processors 120. The I/O interfaces 146 may include connection ports, radio frequency transceivers, and other interfaces configured to communicate with input devices 148 to receive data and with output devices 150 to provide data. In some implementations, the input devices 148 may include a keyboard, a stylus, a trackpad, a mouse, a scanner, a microphone, a camera, other input devices, or any combination thereof. The output devices 150 may include a display, a printer, a speaker, another output device, or any combination thereof. In some implementations, the input device 148 and the output device 150 may be combined in a touchscreen device. Other implementations are also possible.

In operation, the radiation sensor devices 110 may be coupled to vehicles, such as garbage trucks 104, police cars 106, other municipal fleet vehicles 108, post office carrier vehicles, firetrucks, ambulances, security vehicles, bikes, other vehicles, or any combination thereof, which may travel in and around a geographic area, such as a city on the city streets and alleyways. As the vehicles move about, the radiation measurement devices 110 may capture radiation measurements together with timestamps, associated location data, and environmental data. In some implementations, the radiation measurement devices 110 may correlate the radiation measurement data, the timestamp data, and the location data to produce correlated radiation measurement data. The radiation measurement devices 110 may communicate one or more of the correlated radiation measurement data or the raw captured data to the radiation mapping system 102 in real time or when the vehicle returns to its parking lot.

The radiation mapping system 102 may analyze the received data (the correlated radiation measurement data or the raw captured data) relative to background radiation measurement data to determine a difference to determine whether the radiation measurement data is anomalous. If an anomalous measurement is determined, the radiation mapping system 102 may send one or more alerts to one or more of the governmental systems 116, the computing devices 114, the vehicles 104, 106, or 108, or to another device.

In some implementations, the radiation measurement devices 110 may be configured to determine a radiation event or an anomaly. In an example, the radiation measurement devices 110 may determine differences between the radiation measurement data and background radiation measurement data. The radiation measurement devices may compare the differences to one or more thresholds and, when the difference is greater than the threshold, may send an alert to one or more of an on-board computing system of a vehicle (e.g., garbage truck 104, police car 106, fleet vehicle 108, another vehicle, or any combination thereof), a computing device 114 (such as a smartphone, a tablet computer, a laptop computer, a desktop computer, another computing device, or any combination thereof), or the radiation mapping system 102.

One or more of the radiation mapping system 102 or the radiation sensor devices 110 may be configured to process the radiation measurement data to detect anomalies. Such anomalies may be based on a radiation measurement having an amplitude that exceeds a threshold amplitude. The anomalies may be based on a radiation measurement having an amplitude that exceeds that of the background radiation. Alternatively, such anomalies may be determined from a comparison between spectral content of the radiation measurement and spectral content of the background radiation.

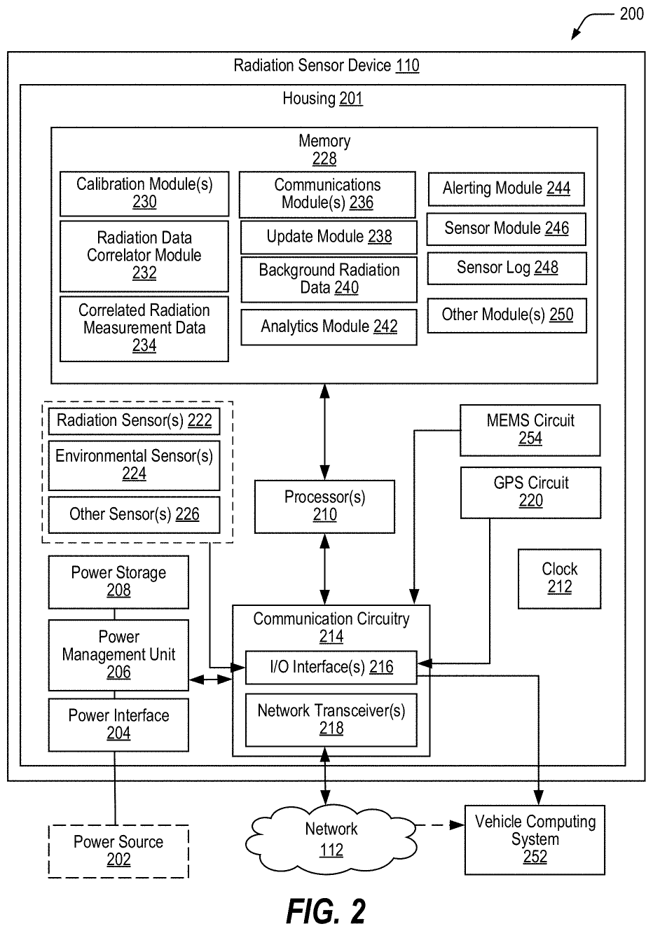

FIG. 2 depicts a block diagram of a system 200 including a radiation sensor device 110 of the radiation mapping system 100 of FIG. 1, in accordance with certain embodiments of the present disclosure. The radiation sensor device 110 may be configured to communicate with the network 112. The radiation sensor device 110 may also be configured to communicate with an in-vehicle computing system, such as a dashboard computer or an integrated computing interface of the vehicle. Additionally, the radiation sensor device 110 may be coupled to power source 202. The power source 202 may be a vehicle battery or alternator of a vehicle. In some implementations, the power source 202 may include a rechargeable battery, which may recharge from the vehicle battery and which may be replaced without replacing the radiation sensor device 110 in response to battery failure. In another example, the power source 202 may include a solar cell or an alternating current power supply, such as for a fixed location sensor device. Other implementations are also possible.

The radiation sensor device 110 may include a power interface 204 coupled to the power source 202. In some implementations, the power interface 204 may include a transformer circuit, a rectifier circuit, a power filter (such as a battery or capacitor), other circuitry, or any combination thereof. The power interface 204 may include one or more connectors configured to couple the power source 202 to the power interface 204. The radiation sensor device 110 may also include a power management unit 206 that may be coupled to the power interface 204 and that may distribute power from the power interface 204 to a power storage device 208, such as rechargeable battery or capacitor. One or more of the power storage 208 or the power management unit 206 may be coupled to other circuit components via a plurality of power buses or wire traces (not shown). In some implementations, the power management unit 206 may be configured to transition one or more of the circuits (such as a processor 210 and communication circuitry 214) between a low power mode and an operating mode based on detecting a power supply at the power interface 204.

In some implementations, in a low-power mode, the power management unit 208 may turn off power to at least some of the circuitry of the radiation sensor device 110 (while continuing to supply power to a clock 212) and may restore power periodically (from the power storage 208) to at least the processor 210 and the communication circuitry 214 to check for a connection to the network 112 or to determine a communication link to the radiation mapping system 102. If the network connection is detected, the power management unit 206 may send radiation measurement data to the radiation mapping system 102 and may return to the low-power mode after the radiation measurement data is sent. Otherwise, if the network connection is not detected, the power management unit 206 may return to the low-power mode. Other implementations are also possible.

The power storage 208 may be configured to receive a power supply from a power source 202, such as a vehicle's battery or electrical system during a measurement phase, such as when the vehicle is moving. The power storage 208 may provide power to the communication circuitry 214 and the processor 210 during a data communication phase. For example, when the vehicle is turned off and power is no longer provided by the vehicle's power systems, the power storage 208 may deliver a power supply to the processor 210 and the communication circuitry 214 to enable the processor 210 to detect a network connection and to send the correlated measurement data to the radiation mapping system 102 if a communications link through the network 112 can be determined.

The radiation sensor device 110 may include one or more processors 210 that may be configured to receive data and execute processor-readable instructions. The radiation sensor device 110 may include a clock 212 that may generate timing signals that can be used by the processor 210 and by other circuitry. In some implementations, the processor 210 may use the timing signals to generate a time stamp.

The radiation sensor device 110 may include communication circuitry 214, which may include one or more input/output interfaces 216, which may couple to one or more sensors, such as one or more radiation sensors 222, one or more environmental sensors 224, one or more other sensors 226, or any combination thereof. The one or more radiation sensors 222 may be configured to generate electrical signals indicative of trace radiation. In an example, the radiation sensor 222 may be implemented as a scintillation detector. Other types of radiation sensors 222 may also be used, including, but not limited to, gamma ray detectors, neutron detectors, scintillation detectors, other types of detectors, or any combination thereof.

The environmental sensors 224 may include temperature sensors, humidity sensors, barometric pressure sensors, other sensors, or any combination thereof. The other sensors 226 may include surface temperature sensors to monitor circuit temperature, as well as other sensors that may monitor one or more parameters that may potentially impact the reliability of measurements by one or more of the radiation sensors 222 or the environmental sensors 224. The I/O interfaces 216 may also communicate with a geophysical location circuit (such as a global positioning satellite (GPS) circuit 220), which may determine location data and provide the location data to the I/O interfaces 216. In some implementations, the I/O interfaces 216 may be coupled to one or more systems associated with a vehicle, such as a touchscreen console or other computing device integrated with or coupled to the vehicle.

The communication circuitry 214 may include one or more short-range network transceivers 218, which may include an 802.11x wireless network transceiver, a Bluetooth network transceiver, a Zigbee transceiver, or other short-range wireless transceivers, or any combination thereof. In some implementations, the communication circuitry 214 may include a citizen's band (CB) radio frequency circuitry, which may be configured to send data using CB radio frequencies. The one or more network transceivers 218 may also include one or more transceivers configured to communicate with a digital, cellular, or satellite communications network. In an example, the communication circuitry 214 may be configured to send radiation measurement data, timestamp data, location data, or any combination thereof to one or more devices through the network 112.

In another implementation, the processor 210 may determine the physical location from the GPS circuit 220 and may determine when the vehicle is at a parking lot or “home” base location. When the processor 210 determines the physical location corresponds to the “home” base, the processor 210 may wait for the vehicle to be turned off and then may use power from the power storage 208 to send the radiation measurement data to the radiation mapping system 102. Other implementations are also possible. In some implementations, the processor 210 may correlate the radiation data to the timestamp data, the location data, and optionally other sensor data (from one or more of the environmental sensors 224 or the other sensors 226) and the communication circuitry 214 may send the correlated radiation measurement data to one or more devices through the network 112.

The radiations sensor device 110 may also include a memory 228. The memory 228 may be configured to store data, such as measurement data from one or more of the radiation sensor 222, the environmental sensors 224 (such as a temperature sensor, a moisture sensor, and other sensors to determine parameters associated with the circuitry), or the other sensors 226 together with associated location data from the GPS circuit 220 and timestamp data determined using the clock 212. The memory 228 may also store instructions that may be executed by the one or more processors 210.

The memory 228 may include one or more calibration modules 230 that, when executed, may cause the processor 210 to calibrate one or more of the radiation sensors 222, the environmental sensors 224, or the other sensors 226. In some implementations, the calibration modules 230 may cause the processor 210 to receive calibration data from one or more of the radiation mapping system 102 or other radiation sensor devices 110 and to use the calibration data to calibrate the one or more radiation sensors 222, the one or more environmental sensors 224, the one or more other sensors 226, and so on. In an example, the radiation sensors 222 may capture radiation measurement data when the vehicles is parked in a parking depot with other vehicles that also have radiation sensor devices 110. Each of the radiation sensor devices 110 may communicate the radiation measurement data to a radiation mapping system 102 while the vehicle is parked. It is expected that this parking lot measurement data should be consistent across the various radiation sensor devices 110 in the same parking lot, and thus radiation measurement data captured by the radiation sensor devices 110 can be used to cross-calibrate each of the radiation sensor devices 110 to a common reference frame. The amount of this common data collected may be augmented by the use of the power storage 208 and power management unit 206 given the common end-of-day and overnight parking locations of municipal vehicles, such as garbage trucks 110(1).

The memory 228 may include a radiation data correlator module 232 that, when executed, may cause the processor 210 to correlate one or more of radiation measurement data from the one or more radiation sensors 222, location data from the GPS circuit 220, environmental data from the environmental sensors 224 or from one or more environmental servers (such as weather servers that may store area weather conditions, rainfall data, and the like, which may impact radiation measurement data across an area), other sensor data from the other sensors 226, or a timestamp from the clock 212. In some implementations, each measurement will be correlated to a timestamp and a location. The radiation data correlator module 232 may cause the processor 210 to store the correlated data as radiation measurement data 234 in the memory 228.

The memory 228 may include one or more communications modules 236 that, when executed, may cause the processor 210 to communicate the correlated radiation measurement data 234 to the radiation mapping system 102. In an example, the communication module 236 may cause the processor 210 to determine when the radiation sensor device 110 is communicatively coupled to the network 112 or to determine when the radiation sensor device 110 is stopped at a “home” location (which may be a repeated geophysical location where the radiation sensor device 110 will be at rest for an extended period of time, such as a parking lot or municipal depot). In response to determining the radiation sensor device 110 is coupled to the network 112 or parked at a home location, the communication modules 236 may cause the processor 210 to send the correlated measurement data 234 through the network 112 to the radiation mapping system 102. In other implementations, the radiation sensor device 110 may send portions of the correlated measurement data to the radiation mapping system 102 at scheduled intervals through a cellular, digital, or other communications link.

The memory 228 may also include an update module 238 that may cause the processor 210 to send data to the radiation mapping system 102 to provide an update indicating that the radiation sensor device 110 is working and that no anomalous radiation measurement has been detected. Updates may be sent periodically, providing status and an “all clear” indication. In the event that an anomalous radiation measurement is detected, the radiation sensor device 110 may use the alerting module 244 to send an alert, as discussed below.

In some implementations, the memory 228 may include an analytics module 242 that, when executed, may cause the processor 210 to compare measurement data (such as raw counts, spectral data, other data, or any combination thereof) from the one or more radiation sensors 222 to corresponding background radiation data 240 to determine differences. The analytics module 242 may also cause the processor 210 to compare the difference to one or more thresholds. In some implementations, the background radiation data 240 may include the one or more thresholds. When the radiation measurement data differs from the background radiation data 240, for example, by more than a threshold amount, the analytics module 242 may cause the processor 210 to determine an anomalous radiation measurement, which may trigger an alert. In an example, the analytics module 242 may cause the processor 210 to compare spectral content of the radiation measurement data to spectral content of the background radiation data 240 to determine differences. The differences may be compared to one or more spectral thresholds to determine an anomalous radiation measurement. Other implementations are also possible.

The memory 228 may include an alerting module 244 that, when executed, may cause the processor 210 to generate alert data and to send the alert data (using the communications modules 236) to one or more devices through the network 112 or to a vehicle computing system 252 through a wired or wireless link in response to determining an anomalous radiation measurement by the analytics module 242. The vehicle computing system 252 may be integrated in a dashboard or may be coupled to the vehicle. When the difference exceeds one or more thresholds, the alerting module 244 may send alert data to the one or more devices, the vehicle computing system 252, or any combination thereof. In an example, when the difference exceeds a first threshold, but not a second threshold, the alerting module 244 may cause the processor 210 to flag or mark the measurement data stored in the radiation measurement data 234 for subsequent review. Alternatively or in addition, the alerting module 244 may cause the processor 210 to send alert data to the vehicle computing system 252, which may alert the driver to circle back to get one or more additional measurements.

When the difference exceeds a second threshold, the alerting module 244 may cause the processor 210 to send alert data to one or more computing devices through the network 112 and to the vehicle computing system 252. In this example, the alert data may indicate radioactive material or a measurement indicative of recent passage of radioactive material near or through the area where the radiation measurement was captured. The alert data may include radiation measurement data, timestamp data, a geophysical location, other data, or any combination thereof. In some implementations, the alert data may be sent to law enforcement for further investigation. Other implementations are also possible.

The memory 228 may include a sensor module 246 that, when executed, may cause the processor 210 to interrogate the one or more sensors, including the radiation sensors 222, the environmental sensors 224, or the other sensors 226 to determine status information. The other sensors 226 may include battery sensors as well as sensors related to signal quality associated with sending and receiving of data by the network transceivers 218. The status information may be stored in a sensor log 248 and, in some implementations, may trigger the alerting module 244 to generating an alert including sensor data indicative of the status of one or more of the components of radiation sensor device 110. For example, if one of the sensors 222, 224, of 226 is failing, the sensor data may indicate a problem with the sensor, which may trigger an alert suggesting maintenance of a sensor or component. In another example, data indicative of signal errors associated the communication circuitry 214 may trigger an alert requesting maintenance associated with the transceiver. In still another example, data indicative of recharging issues or power issues related to the battery may trigger an alert indicating a battery or power issue. Other implementations are also possible.

The memory 228 may include other modules 250 that, when executed, may cause the processor 210 to perform other operations. In some implementations, the other modules 250 may trigger operations such as upgrades and the like. Other implementations are also possible.

The radiation sensor device 110 may include a micro-electro-mechanical system (MEMS) circuit 254, which may be used to determine movement of the radiation sensor device 110 (in conjunction with the location data from the GPS circuit 220). In some implementations, the radiation sensor device 110 may be activated in response to movement determined by the MEMS circuit 254 or in response to receiving power from the power source 202. In operation, the radiation sensor device 110 may capture radiation measurements at a selected frequency, such as one Hertz. In some implementations, the processor 210 may cause the radiation sensors 222 to capture radiation measurement data at a frequency that may vary with the speed of the vehicle, so that the radiation sensors 222 may capture data every thirty meters, 20 meters, or some other distance. In the event that the vehicle is running but not moving, the radiation sensors 222 may capture radiation measurement data at a selected frequency, such as every five minutes.

The radiation sensor device 110 may be implemented in a variety of form factors and using off-the-shelf or proprietary circuits. In some implementations, the radiation sensor device 110 may include a printed circuit board with a plurality of components, such as a general-purpose processor, a non-volatile memory, and the sensors as described above. In other implementations, the radiation sensor device 110 may be implemented using a field-programmable gate array or other programmable circuit. In one possible implementation, the radiation sensor device 110 may be implemented as a Rasberry Pi computing circuit, which is commercially available from Rasberry Pi (Trading) Limited of Cambridge, United Kingdom. Other configurable circuits may also be used.

In some implementations, the processor 210 may be configured to selectively control a frequency of operation of the one or more radiation sensors 222 to capture the radiation measurement data based on changes to the physical location data. In an example, the processor 210 may control the frequency based on a speed that the radiation sensor device 110 is moving so that the radiation sensor 222 captures a radiation measurement each time the radiation sensor device 110 moves a certain distance, such as every fifty meters, every one hundred meters, or another distance. The processor 210 may correlate the radiation measurement data to the physical location data and the timestamp. The processor 210 may determine an anomalous radiation measurement when the spectral content of the radiation measurement data exceeds a spectral threshold and, in response to determining the anomalous radiation measurement, may send an alert one or more computing devices 114 (the governmental system 116 or the radiation mapping system 102) through the communications network 112. The alert may include one or more of a small message system text message, an email message, an audio message, or a web page including information related to the anomalous radiation measurement.

In some implementations, the processor 210 of the radiation measurement device 110 may determine the anomalous radiation measurement by determining differences between the spectral content of the radiation measurement data and spectral content of the background radiation measurement data 240 for the physical location and may determine the anomalous radiation measurement when one or more of the differences exceed one or more of the spectral thresholds. In some implementations, the processor 210 may determine a sensor error when, for a selected location, the radiation measurement data is less than the background radiation measurement data 240 by more than a threshold amount, which may indicate a problem with the radiation sensor 222.

In some implementations, the radiation sensor device 110 may include a housing 201 defining an enclosure to protect the one or more sensors 222, 224, and 226, the GPS circuit 220, the clock 212, the one or more communication interfaces (communication circuitry 214), and the processor 210, the memory 228, the power storage 208, the power management unit 206, the power interface 204, and other circuitry from contamination, such as road surface debris, moisture, and so on. The housing 201 may be formed from plastic, aluminum, carbon fiber, steel, composite materials, or any combination thereof. The housing 201 may be rigid and may be configured to couple to a vehicle, such as the vehicles 104, 106, and 108 described with respect to FIG. 1, to protect the circuitry from the environment. In some implementations, the housing 201 may be ruggedized for exposure to harsh environmental conditions. In an example, the housing 201 for a radiation sensor device 110 to be applied to a garbage truck 104 may have a housing designed to withstand impacts from trash, rocks, or debris in a landfill environment.

In some implementations, the one or more sensors may include one or more environmental sensors 224 configured to provide data indicative of at least one environmental parameter, such as moisture, temperature, and so on. The processor 210 may be configured to determine one or more corrections to be applied to the radiation sensor measurement data based on the at least one environmental parameter. In an example, the processor 210 may utilize temperature data to correct for drift or other errors in the radiation sensor measurement data.

In some implementations, the processor 210 of the radiation sensor device 110 may be configured to determine the physical location data from the GPS circuit 220 and to determine a communication link to a radiation mapping system 102 through the communication network 112 using the one or more communications interfaces (communication circuitry 214 or network transceivers 218). The processor 210 may provide the correlated radiation measurement data to the radiation mapping system 102 through the communication network 112.

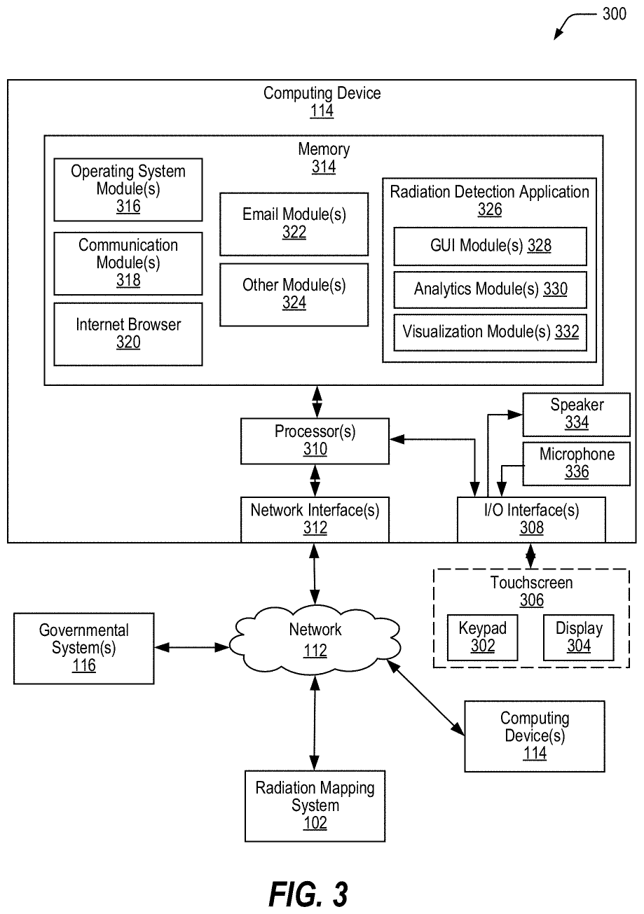

FIG. 3 depicts a block diagram 300 of a computing device 114 that may communicate with the radiation monitoring system 102 of FIG. 1, in accordance with certain embodiments of the present disclosure. The computing device 114 may include a smartphone, a laptop computer, a tablet computer, a desktop computer, an in-vehicle computing system, another computing device, or any combination thereof. The computing device 114 may communicate with the governmental systems 116, radiation mapping systems 102, radiation sensor devices 110, other computing devices 114, or any combination thereof through the network 112. Additionally, the computing device 114 may include or may be coupled to a keypad 302 and a display 304. In some implementations, the keypad 302 and the display 304 may be implemented as a touchscreen 306, which may present data (including text data, images, other data, or any combination thereof) and receive inputs from a user.

The computing device 114 may include one or more input/output (I/O) interfaces 308, which may be coupled to the keypad 302 and the display 304 (or the touchscreen 306). The computing device 114 may also include a processor 310, which may be coupled to the one or more I/O interfaces 308, to one or more network interfaces 312 (which may communicate with the network 112), and to a memory 314. The computing device 114 may also include a speaker 334 and a microphone 336, which may be coupled to the one or more I/O interfaces 308.

The memory 314 may include a non-volatile memory configured to store data and to store processor-readable instructions. In some implementations, the memory 314 may store operating system modules 316 that may control operation of the computing device 114. The memory 314 may also store communication modules 316 that, when executed, may cause the processor 310 to communicate data to and from the one or more I/O interfaces 308 or the one or more network interfaces 312. The memory 314 may also include an Internet browser application 320 that, when executed, may cause the processor 310 to present an interface to the display 304 (or touchscreen 306) and to receive inputs corresponding to the interface from the keypad 302 or touchscreen 306 (or from a pointer, such as a mouse, a stylus, or a user's touch). In some implementations, the graphical interface of the Internet browser application 320 may render a graphical interface (based on data from the radiation mapping system 102) to display radiation measurement data, control options for viewing radiation measurement data, alert data, one or more visualizations, or any combination thereof.

The memory 314 may include one or more email modules 322 that, when executed, may present an electronic mail interface, a text interface, or another electronic communication interface to send and receive electronic messages. The memory 314 may also include other modules 324 that may be executed by the processor 310 to perform various functions, such as printing, providing audio outputs to the speaker 334, receiving audio input from a microphone 336, text-to-speech conversion, and so on.

The memory 314 may include a radiation detection application 326 that, when executed may communicate with the radiation mapping system 102 to receive radiation measurement data and other data. The radiation detection application 326 may include one or more graphical user interface modules 328 that may cause the processor 310 to provide a user interface to the display 304 (or touchscreen) that may include text data, image data, and user-accessible controls (such as tabs, clickable links, buttons, interactive maps, other control elements, or any combination thereof).

The radiation detection application 326 may include one or more analytics modules 330 configured to process data received from the radiation mapping system 102 and to determine alerts and other information related to the radiation measurement data, the background radiation data, or any combination thereof. The radiation detection application 326 may also include one or more visualization modules 332 that may be used by the radiation detection application 326 to present radiation measurement data in one or more selected visualizations (such as bar graphs, dynamic radiation maps, pie graphs, line graphs, heat maps, and so on). In some implementations, a user may interact with a pulldown menu or other control option to select between visualizations. In some implementations, the user may select a sub-division or grid within an area on a visualization to view underlying data. Other implementations are also possible.

In some implementations, the analytics may be performed by the radiation mapping system 102 and the processed data may be provided to one or more of the radiation detection application 326 or the Internet browser application 320. In an example, a user may utilize the Internet browser application 320 to access a graphical interface (web page) provided by the radiation mapping system 102. The web page may require a login. Based on a successful login, the web page may display a graphical interface including radiation measurement data for an area associated with the user (for example, an area with which a user's account is associated within the system). Alternatively, the user may utilize the radiation detection application 326 to view the measurement data and various visualizations of that data. The radiation detection application 326 may render a graphical interface based on data from the radiation mapping system 102, and the visualizations and the analytics may be provided to the radiation detection application 326 by the radiation mapping system 102.

In other implementations, the raw data may be provided to the radiation detection application 326, and the radiation detection application 326 may process the raw data. The user may interact with the graphical interface produced by the radiation detection application via the touchscreen 306 to view radiation measurement data. In this example, the GUI modules 328 may provide one or more user-selectable controls that can be accessed by a user to configure various thresholds and filters in order to provide customized alerting, such as specifying how, when, and for what type of radiation anomaly event that a user may wish to receive an alert.

In some implementations, the graphical interface may include control options, such as tabs, clickable links, buttons, pulldown menus, and the like), and the user may interact with one or more of the control options to switch between visualizations, to select data, and so on. Other implementations are also possible.

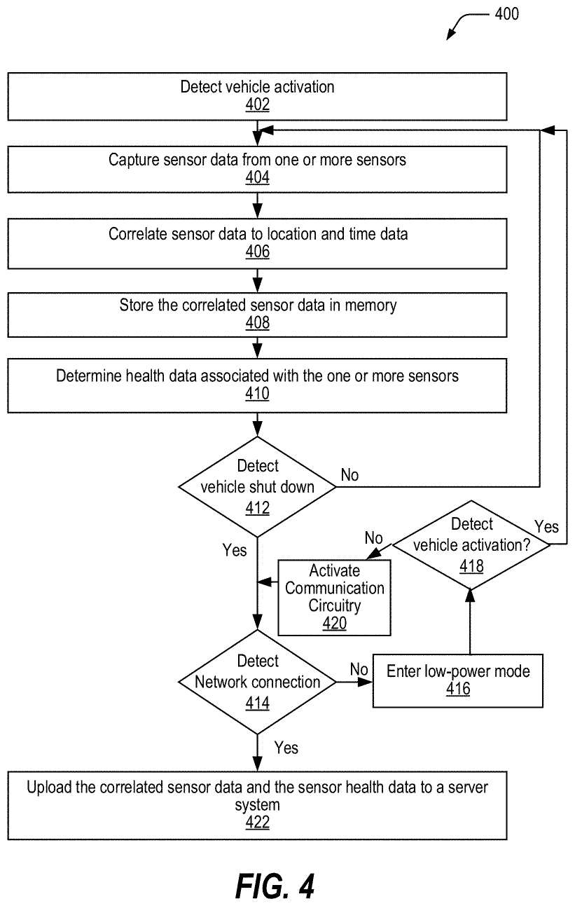

FIG. 4 depicts a flow diagram of a method 400 of providing captured radiation data to a server system, in accordance with certain embodiments of the present disclosure. At 402, the method 400 may include detecting vehicle activation. The vehicle activation may be determined from a “power on” event, based on detection of movement of the vehicle, or based on other parameters. In an example, a power management unit 206 of a radiation sensor device 110 may detect a change in a power supply received from an electrical system (such as the alternator) of a vehicle. The change in the power supply may be a transition from no power to a power level that is above electrical ground. In another example, the change may be a transient change that may be caused by a starter of the vehicle drawing power from the battery. Detection of other changes in the supply voltage may also be possible.

At 404, the method 400 may include capturing sensor data from one or more sensors. Sensor data may be captured by the radiation sensors 222, environmental sensors 224, and other sensors 226, which may generate electrical signals proportional to one or more parameters, and the sensor data may be captured by sampling the electrical signals. The sensor data may be captured periodically, at predefined distance intervals, at predetermined timing intervals, according to a schedule, or any combination thereof. The sensor data may include radiation measurement data, temperature data, humidity data, other data, or any combination thereof. In some implementations, the radiation sensor device 110 may delay capturing sensor data until the radiation sensor device 110 is within a predefined area. Once the radiation sensor device 110 is within the predefined area, the radiation sensor device 110 may captured radiation measurement data, location data, timestamp data, and other data according to a selected frequency or distance intervals.

At 406, the method 400 may include correlating the sensor data to location and time data. In some implementations, the radiation sensor device 110 may capture GPS data and timestamp data and may correlate the radiation measurement data, environmental data (e.g., temperature), and other sensor data to the GPS data and the timestamp. In some examples, in addition to location data and timestamp data, the radiation sensor device 110 may also correlate the radiation measurement data with the sensor data from each of the sensors together with the location data and timestamp data.

At 408, the method 400 may include storing the correlated sensor data in memory. The correlated sensor data may be stored in a non-volatile memory (such as a hard disc or flash drive) of the radiation sensor device 110. In some implementations, the data may be stored in a database in the nonvolatile memory. In other implementations, the data may be stored in a table or other data structure.

At 410, the method 400 may include determining health data associated with the one or more sensors. The health data may be determined using one or more of the other sensors 226 or may be determined from signal strength data or other data. In an example, the radiation sensor device 110 may monitor a power level, a battery health indicator, or other data to determine that the radiation sensor device 110 may require servicing.

At 412, the method 400 may include determining whether the vehicle is shut down. In an example, the radiation sensor device 110 may determine the vehicle's state based on a change in the power supply. For example, the engine shutting down may produce a change in the power level. If, at 412, the vehicle is still active, the method 400 returns to 404 to capture sensor data. Otherwise, if the vehicle is shut down at 412, the method 400 may include detecting a network connection, at 414. If no network connection is detected, the method 400 may include entering a low-power mode, at 416. The low-power mode may include the power management unit 206 turning off power to various circuits.

The method 400 may include detecting vehicle activation, at 418. In some implementations, in the low-power mode, the power management unit may periodically wake up and activate communication circuitry to detect vehicle activation or to determine the presence of a network connection.

If the vehicle is activated at 418, the method 400 may return to 404 to capture sensor data. Otherwise, if the vehicle remains shut down, the method 400 may include waiting for a period of time and then activating communication circuitry, at 420. Periodically, the power management unit 206 may turn on power to the communication circuitry 214 to test for a network connection. The method 400 may include checking for a network connection again, at 414.

Returning to 414, if the network detection is detected, the method 400 may include uploading the correlated sensor data and sensor health data to a server system, at 422. The correlated sensor data and sensor health data may include raw sensor measurement data. In another example, the correlated sensor data may include a difference between the radiation measurement data and the background radiation measurement data, correlated with a timestamp, location data, and other sensor data. Other implementations are also possible. In some implementations, the server system may be an implementation of the radiation mapping system 102 in FIG. 1.

In some implementations, such as when the radiation sensor device 110 is coupled to a vehicle, the radiation sensor device 110 may determine when the vehicle is returned to its storage parking lot or parking depot (based on location data from the GPS circuit 220), and then may couple to a known network, such as a local area network, to upload the correlated measurement data, the raw data, other data, or any combination thereof. In other implementations, the data may be transmitted through any available network link, such as via a cellular, digital, or satellite network. In some implementations, the radiation sensor device 110 may periodically communicate an “all is well” message to the radiation mapping system 102 when no anomalous radiation measurement is determined. The message may include location data and an indicator that the radiation measurement data is within an expected range.

The radiation mapping system 102 may collect data from multiple radiation sensor devices 110 and may aggregate the data for each of the locations over time to determine background radiation data for each of a plurality of locations. The background radiation data can be used to compare to spectral data from current radiation measurements to spectral data of the background radiation data to determine anomalous radiation measurements.

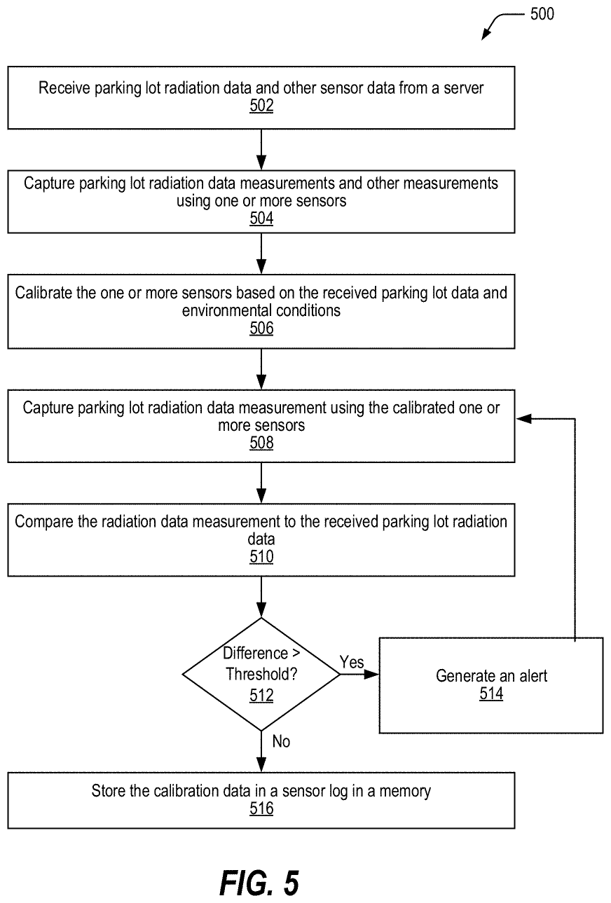

The radiation sensor devices 110 include a plurality of sensors. To ensure accurate data, it may be desirable to calibrate the sensors prior to capturing radiation measurement data. In example, while multiple radiation sensor devices 110 are located in relatively close proximity (such as in a parking lot), the radiation measurement data, temperature data, humidity data, and other sensor data may be used to calibrate each of the sensors so that the radiation sensor devices 110 are calibrated before they are dispatched. An example of a calibration process, which may be performed automatically, is described below with respect to FIG. 5.

FIG. 5 depicts a flow diagram of a method 500 of calibrating a radiation sensor device 110 based on background measurement data, in accordance with certain embodiments of the present disclosure. In this example, the radiation sensor device 110 may capture radiation measurements while the vehicle is parked in a parking lot (for example) with other vehicles that include radiation sensor devices 110. Each of the radiation sensor devices 110 may capture radiation measurements and other sensor data, which may be shared with the radiation mapping system 102 or with other radiation sensor devices 110. The measurement data may be compared to similar measurements by other radiation sensor devices 110 in the parking lot, making it possible for the processor of the radiation sensor device 110 or the processor of the radiation mapping system 102 to perform a calibration operation. Due to the stability of radiation measurements over time, the collection of parking lot data 502 from different sensors need not necessarily overlap in time and could, for example, be captured on different days or weeks.

At 502, the method 500 may include receiving parking lot radiation data and other sensor data from a server. In an example, the radiation mapping system 102 (of FIG. 1) may receive radiation measurement data as well as temperature, humidity, and other sensor measurements from a plurality of radiation sensor devices 110 in a common location. The radiation mapping system 102 may provide the radiation data to each of the radiation sensor devices 110.

At 504, the method 500 may include capturing parking lot radiation measurements using one or more sensors. In an example, after receiving the radiation data (such as a control signal to initiate a calibration operation) from the radiation mapping system 102, the radiation sensor device 110 may capture radiation measurements, environmental data, and other data.

At 506, the method 500 may include calibrating the one or more sensors based on the received parking lot data and environmental conditions from the radiation mapping system 102. In an example, the radiation mapping system 102 may determine a difference between the measurement data and that of the received parking lot radiation data and other sensor data and may determine one or more adjustments for a selected one of a plurality of the radiation sensor devices 110, which may be applied by the processor of the radiation sensor device 110 to calibrate one or more sensors.

At 508, the method 500 may include capturing a parking lot radiation measurement using the calibrated one or more sensors. In some examples, the radiation sensor device 110 may take a new measurement to verify the calibration. The new radiation measurement data may be sent to the radiation mapping system 102 to confirm the calibration.

At 510, the method 500 may include comparing the radiation data measurement to the received parking lot radiation data. The radiation mapping system 102 may perform the comparison. If the one or more sensors are calibrated correctly, the comparison should result in a difference that is relatively small and that should be within a margin of error.

At 512, if the difference is greater than a threshold difference, the method 500 may include generating an alert, at 514. In some implementations, the alert may be indicative of a sensor error or a radiation sensor device 110 that is out of calibration and that may require service. In other implementations, the alert may trigger the generation of a new set of calibrations based upon the most recent data or a larger aggregation of time. The alert may be sent to the radiation sensor device 110 and may include further adjustments, which may be applied by the processor of the radiation sensor device 110 to further calibrate the one or more sensors. In this example, the method 500 may return to 508 to capture parking lot radiation measurement data again. The measurement may then compared at 510 and the difference may be compared to a threshold at 512. In some implementations, if this process is repeated multiple times and the sensor data remains out of calibration, the alert 514 may be sent to one or more computing devices 114 to initiate a service operation.

Returning to 512, if the difference is less than or equal to the threshold, the method 500 may include storing the calibration data in a sensor log in a memory, at 516. In some implementations, the calibration data may include one or more of adjustment data, parameters, coefficients, or other information including, for example, a timestamp indicating when the calibration was performed. Other implementations are also possible.

Calibration of the radiation sensor device 110 may be performed automatically when a vehicle is activated. Alternatively, the calibration may be performed automatically after the radiation sensor device 110 uploads the data to the radiation mapping system 102. In some implementations, the calibration operation may be triggered by a user selecting an option on an in-vehicle computing system, which may communicate a control signal to the radiation sensor device 110 to initiate the calibration operation. Other implementations are also possible.

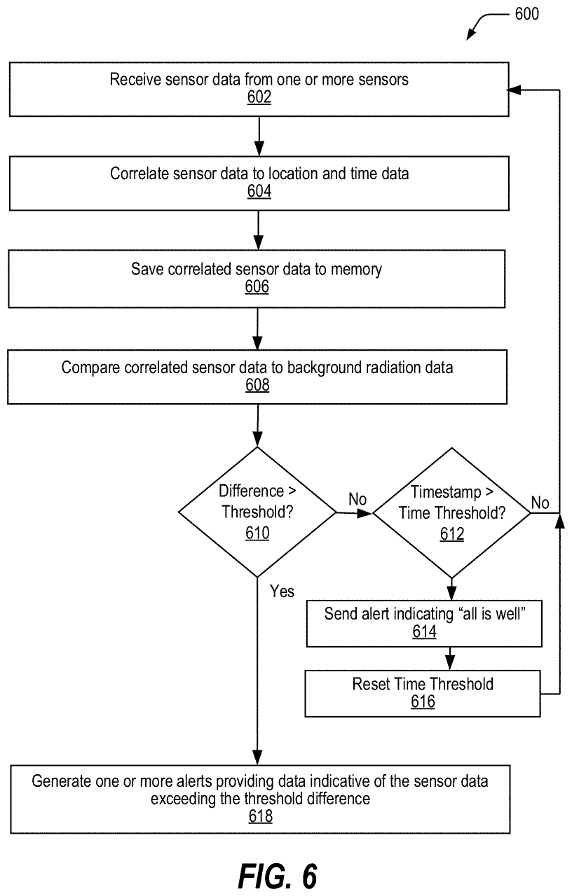

FIG. 6 depicts a flow diagram of a method 600 of generating an alert in response to detecting a radiation measurement that exceeds a threshold, in accordance with certain embodiments of the present disclosure. The method 600 may be performed by the radiation sensor device 110, by the radiation mapping system 102, or by both the device 110 and the system 102.

At 602, the method 600 may include receiving sensor data from one or more sensors. In one implementation, the sensor data may be received from one or more radiation sensor devices 110 at the radiation mapping system 102. In another implementation, the sensor data may be received at a processor 210 of the radiation sensor device 110 from one or more sensors (including radiation sensors 222, environmental sensors 224, and other sensors 226) at a processor 210 of a radiation sensor device 110.

At 604, the method 600 may include correlating sensor data to location data and time data. In some implementations, the processor 210 of the radiation sensor device 110 may correlate the GPS location data and timestamp to each radiation measurement. In other implementations, the processor 120 of the radiation mapping system 102 may receive blocks of data (including radiation measurement data, location data, timestamp data, other data, or any combination thereof) and may correlate the radiation measurements and optionally other sensor data to the location data and the timestamp data.

At 606, the method 600 may include saving the correlated sensor data to a memory. The correlated sensor data may be stored in a database at the radiation mapping system 102 or in a datastore of a memory of the radiation sensor device 110.

At 608, the method 600 may include comparing the correlated sensor data to background radiation data. In some implementations, either the radiation mapping system 102 or the radiation sensor device 110 may compare the spectral content of the radiation measurement data associated with a selected location to spectral content of the background radiation data of the selected location. The comparison may be based on raw counts, spectral data, other data, or any combination thereof.

At 610, if the difference between the spectral content the radiation measurement data and the spectral content the background radiation data is less than or equal to a threshold, the method 600 may include determining if the timestamp is greater than a time threshold, at 612. In an example, periodic reporting may be enabled such that the radiation measurement device 110 may periodically send a signal to the radiation mapping system 102 to indicate that the radiation measurement data that has been collected by the radiation sensor device 110 has been within an acceptable range since the last report was sent. In operation, a large percentage (such as 99.7% of the time) of the messages received from the radiation sensor device 110 may indicate that “all is well.”

At 612, if the time interval has not been exceeded, the method 600 may to 602 to receive sensor data from the one or more sensors.

Otherwise, at 612, if the timestamp exceeds the time threshold, the method 600 may include sending an alert indicating that “all is well.” This alert may include location data corresponding to locations at which radiation measurement data has been captured and an indicator that the radiation measurement data was within an acceptable range.

At 616, the method 600 may include resetting the time threshold 612 to define a new period of time. The method 600 may then return to 602 to capture radiation measurement data and other data.

Returning to 610, if the difference is greater than the threshold, the method 600 may include generating one or more alerts providing data indicative of the sensor data exceeding the threshold difference, at 618. The one or more alerts may include one or more of a text message, an audio message, a phone call, an email message, a popup within a graphical interface, another visual indicator, or any combination thereof. The one or more alerts may be generated by one or more of the radiation mapping system 102 or the radiation sensor device 110. The alerts may be sent to one or more of a computing system of a vehicle 104, a computing device 114, a governmental system 116, or any combination thereof. In some implementations, the radiation sensor device 110 may generate the alert and may send it to the radiation mapping system 102 directly or through an intermediary system, such as an in-vehicle computing system. Other implementations are also possible.

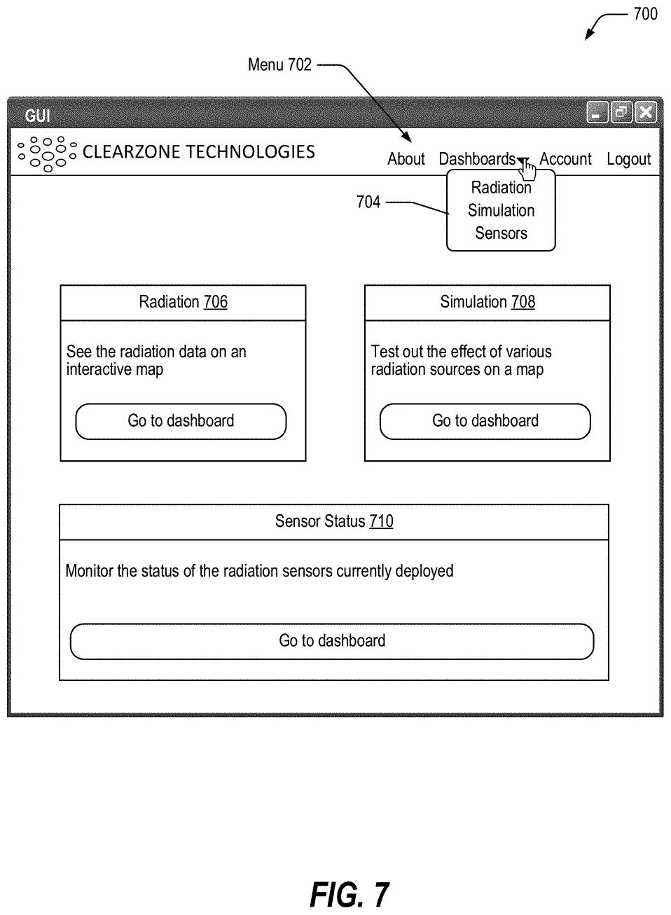

FIG. 7 depicts a graphical interface 700 including user-selectable controls to access radiation data, simulation data, and sensor status data, in accordance with certain embodiments of the present disclosure. The user-selectable controls may include menus 702, tabs, pull-down menus 704, buttons, clickable links, text fields, radio buttons, checkboxes, other selectable controls, or any combination thereof, which may be accessed by a user to view radiation measurement data, switch between visualizations of the radiation measurement data, review sensor status data, review simulation data, enter data, access account data, and so on.

The GUI 700 may include a menu 702 comprised of clickable control links, buttons, or tabs. The menu 702 may be accessed by a user by directing a pointer (a finger, a mouse pointer, a stylus pointer, or other selection control element) onto one of the menu options and selecting the menu option (such as by clicking the mouse, tapping the screen, or by performing another selection method). In this example, the menu 702 may include an “About” control option that may be selected to review information about a company hosting the information, about the GUI 700, about the data presented within the GUI 700, other information, or about any combination thereof. The menu 702 may include an “Account” control option that may be accessed by a user to review account information, such as alert selections (e.g., email, text, and so on), user information, password information, other preferences, or any combination thereof. The menu 702 may include a “Logout” control option that may be accessed by the user to logout of the system.

The menu 702 may include a “dashboards” control option that may be accessed by positioning a pointer over the “dashboards” control option, by selecting the “dashboards” control option, by selecting an “expand” button associated with the “dashboards” control option, or by another selection. In response to selecting the “dashboards” control option, the GUI 700 may present a popup or pull-down menu 704 including a list of selectable control options for accessing selected ones of a plurality of available dashboards. Each dashboard may present radiation measurement data, radiation sensor device data, simulation data, other data, or any combination thereof in one or more visualizations, which may include graphs, lists, text descriptions, images, or any combination thereof. In this illustrative example, the dashboards may include a radiation dashboard that may display background radiation data, current radiation data, other sensor measurement data, or any combination thereof. The dashboards may also include a “Simulation” dashboard that may display simulated data, which may be used for test purposes. The dashboards may include a “Sensors” dashboard, which may provide information related to sensors of a plurality of radiation sensor devices 110. The sensors dashboard may include information about the various sensors, including identifying one or more sensors that may require service. Other dashboards may be added or the listed dashboards may be expanded or replaced with other visualizations or other data, depending on the implementations.

In this example, the GUI 700 may represent an illustrative, non-limiting example of a landing page that may be presented to a user in response to an initial login. The GUI 700 may be presented by the radiation mapping system 102 or by one or more computing devices 114. The GUI 700 may be part of a radiation detection application 326 of the computing device 114 or may be a web page rendered within the Internet browser application 320. The GUI 700 may present information and user-selectable control options accessible by a user to access selected information.

In some implementations, the “Account” control option in the menu 702 may be accessed by a user to configure or select a landing page, such that the user may be directed to the “radiation” dashboard immediately upon successfully logging in, for example. In other implementations, the “Account” control can limit the geographic extent of visibility of the radiation data.

In the illustrated example, the GUI 700 depicts several boxes that may include control options accessible by a user to select between the different dashboards. The boxes may include a radiation option 706, which may be accessed by a user to view the radiation measurement data on one or more interactive maps. The boxes may include a simulation option 708, which may be accessed by the user to view an interactive map in which a user may test the impact of various radiation sources on the visualization. The boxes may include a sensor status option 710, which may be accessed by the user to view the status of radiation sensors that are currently deployed and optionally to review the status of other sensors of the radiation sensor devices 110.

In some implementations, selection of one of the menu control options 702, the control options of the pull-down menu 704, the radiation control option 706, the simulation control option 708, or the sensor status control option 710 may cause the GUI 700 to submit a request to the radiation mapping system 102 (such as to load another web page or to retrieve the selected information. In some implementations, the GUI 700 may retrieve data from the radiation mapping system 102 and may render one or more visualizations based on the retrieved data. Other implementations are also possible.

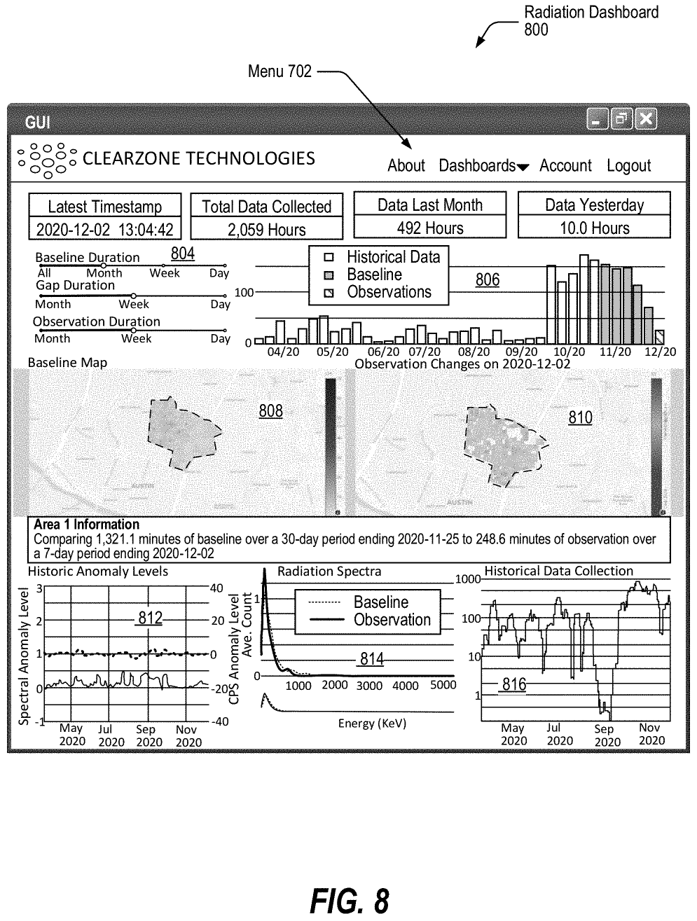

FIG. 8 depicts a GUI 800 including user-selectable controls and including radiation measurement data, in accordance with certain embodiments of the present disclosure. The GUI 800 may be an illustrative example of the radiation measurement data dashboard, which may be accessed by selecting the radiation control option from the pull-down menu 704 in FIG. 7 or by selecting the radiation control option 706 in FIG. 7.

In the illustrated example, the GUI 800 may include data related to radiation measurements captured by a plurality of radiation sensor device, including background radiation measurement data and any anomalous radiation measurements in multiple visualizations. In this example, the latest radiation measurement data was timestamped at 1:04 PM on Dec. 2, 2020. The GUI 800 indicates a total number of hours of data collection and a number of hours of data collection in the previous month (e.g., November 2020). The GUI 800 may also include the number of hours of data collection on the previous day (e.g., Dec. 1, 2020).

The GUI 800 may include a first visualization control option 804 that may allow the user to select a timeline for baseline data, historical data, and observations data, which may be presented in a bar graph 806. The baseline duration is currently set for a month, while the gap duration and the observation duration are set for one week. The bar graph 806 may reflect the settings of the control option 804.

The GUI 800 may include a background radiation map 808, which may depict background radiation measurement data for a selected area (Area 1 indicated by the area outlined on the map 808 by the dashed lines). The GUI 800 may also include an observation changes map 810 depicting radiation measurement data captured over a selected time frame. In some implementations, the user may interact with the maps 808 and 810 to adjust the area over which the baseline and measurement data are displayed. For example, the user may narrow the area to a smaller subdivision or grid within the area by clicking on the map and selecting one or more subdivisions. Other implementations are also possible.

In this example, the radiation measurement background data in the map 808 was collected over a thirty-day window of time ending on Nov. 25, 2020, and the observation changes map 810 may reflect the radiation measurement data over a seven-day period ending on Dec. 2, 2020. In some implementations, the GUI 800 may include a control option to adjust the start and end dates for the maps 808 and 810. In an example, the user may access the control option to adjust the start and end dates by clicking on one of the maps 808 or 810. Other implementations are also possible.

The GUI 800 may include a line graph 812 of historical spectral anomaly data over time including a baseline (dotted line) and observation data (solid line). The GUI 800 may include a line graph 814 of an average count of anomaly data verses energy level in Kilo-electrovolts. The GUI 800 may include a line graph 816 of historical radiation measurement data counts over time.

The graphs, maps, and control options described with respect to the GUI 800 are intended to be illustrative only and are not intended to be limiting. Other data and other visualizations of the data may be presented in the GUI 800, depending on the implementation and on the user. In some examples, different users may have different access levels, and the data presented in the GUI 800 may depend on the access level of the user. Other implementations are also possible.

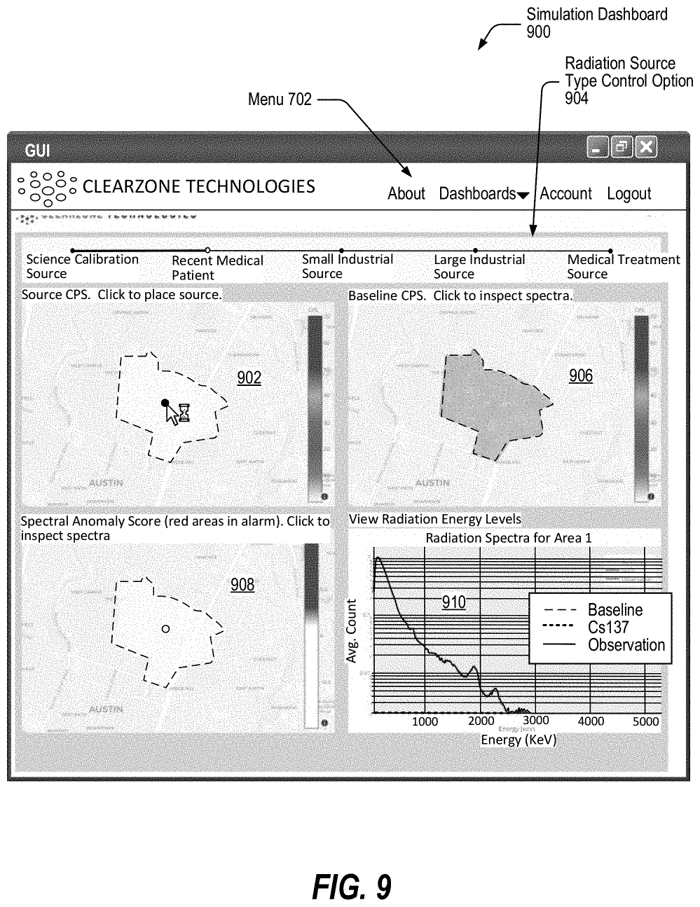

FIG. 9 depicts a graphical interface 900 including user-selectable controls and including simulation data, in accordance with certain embodiments of the present disclosure. The GUI 900 includes the menu 702, which enables navigation between the various GUIs 700, 800, and 900, for example. In this example, the GUI 900 may include a first interactive map 902 that is accessible by a user to place a radiation source within a selected area, which, in this instance, is indicated by the dashed line of Area 1 (mentioned above with respect to FIG. 8). A mouse pointer depicts placement of a radiation source at a center of the area (which source is represented here as a solid black circle). The user may access a radiation source type control options 904 to specify a type of radiation source, such as a science calibration source, a recent medical patient source, a small industrial source, a large industrial source, a medical treatment source, another source, and so on. In this example, the user has selected “recent medical patient” as the radiation source. It should be appreciated that the size of the circle in this illustrative example is not to scale, but the data is presented here in a size that is large enough to be readily seen in the drawings.

In operation, a user may interact with one or more selectable controls within the GUI 900 to adjust the size of the areas, to adjust the time window, to change visualizations, or any combination thereof.

The GUI 900 may include a baseline background radiation map 906 that depicts the selected area (area 1) and shows the background radiation measurement spectra for the area. In this example, the baseline map 906 may be interactive to allow the user to select a portion of the map to inspect the radiation measurement spectra.

The GUI 900 may include a spectral anomaly score map 908, which may show the radiation source on the map as radiation spectral anomaly. If the radiation source represents a potential problem or concern, the spectral anomaly score map 908 may present the radiation source in a color indicative of the threat level.

The GUI 900 may include a line graph 910 of radiation spectra for the selected area (Area 1), which depicts the average count versus the energy level for baseline data (shown in dashed line), Cesium 137 radiation shown in dotted line, and an observation (radiation measurement data). The data presented on the graph 910 may be determined by the type of radiation selected via the radiation type control options 904 above. Other implementations are also possible.

The GUI 900 provides an interface that may allow a user to explore how the GUI 900 may represent different types of radiation sources, their expected energy levels, and their respective threat levels. The user may select one or more of the maps 902, 906, and 908 to make adjustments and to inspect the underlying data. In other implementations, the simulation may also convey the estimates of the likelihood of observing such an event. For example, there are approximately one million radioactive cancer treatments per year in the United States and 20% of these cancer-treated individuals may carry residual radiation after they leave the hospital. This residual radiation will be visible to the radiation sensor devices 110 over the course of three weeks. In contrast, the number of unsecured Medical Treatment Sources is roughly one per every ten years across the world. Other implementations are also possible.

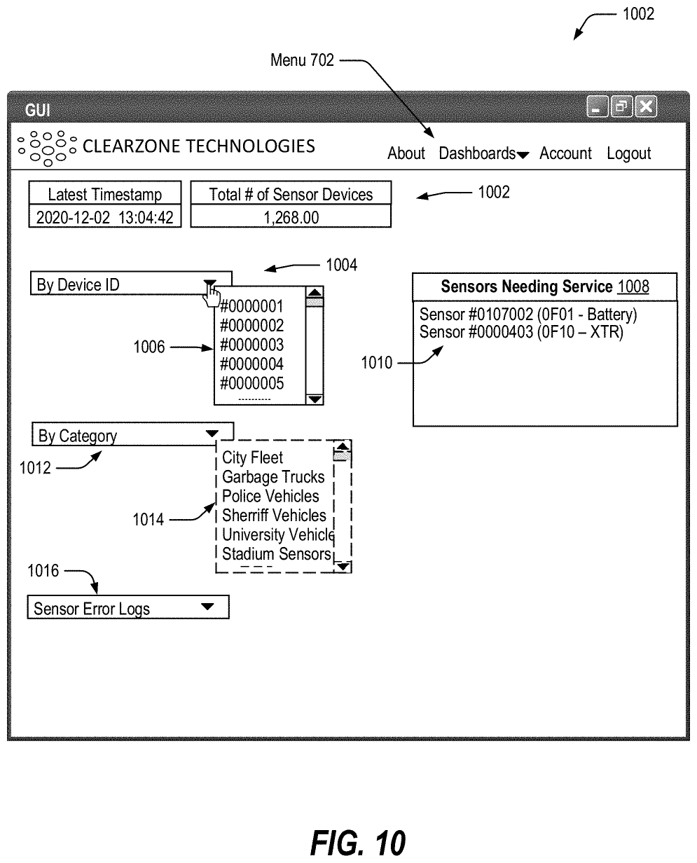

FIG. 10 depicts a GUI 1000 including user-selectable controls and including radiation sensor data, in accordance with certain embodiments of the present disclosure. The GUI 1000 may depict sensor status data for one or more of the radiation sensor devices 110. In this example, the GUI 1000 includes the menu 702. Additionally, the GUI 1000 may include a count of the total number of radiation sensor devices 110.

The GUI 1000 may include a pulldown menu 1004 that may be accessed by a user to view a list 1006 of radiation sensor devices 110. In this example, the list 1006 may include a plurality of serial numbers. Alternatively, one or more of the radiation sensor devices 110 may be named or otherwise coded, and the name or code may be included in the list 1006.

The GUI 1000 may include a pulldown menu 1012 that may include a list 1014 of vehicle types or categories on which the one or more sensor devices 110 are deployed. In this example, the list 1014 may include city fleet vehicles, garbage trucks, police vehicles, sheriff vehicles, university vehicles, stadium sensors, and so on. In some implementations, the user may interact with the pulldown menu 1012 to review radiation sensor devices 110 that are deployed on a particular type of vehicle.

The GUI 1000 may include a pulldown menu 1016 that may allow a user to access sensor error logs for each of the one or more radiation sensor devices 110. In the event of an error, the radiation sensor device 110 may record error data, such as an error code and associated state information. The radiation sensor device 110 may provide the error data to the radiation mapping system 102, which may store the error data in a memory, segregated according to each radiation sensor device 110 so that the error log data may be analyzed to determine if a particular radiation sensor device 110 may require service.

In this example, the GUI 1000 may include a text box or display area 1008 indicating one or more sensors that may be in need of service. In this example, the display area 1008 may include a sensor identification and an error code indicative of the type of error. For example, a first sensor (sensor #0107002) may have an error code (0F01), which may be indicative of a battery problem, such as the battery is not holding a charge or another battery error. Additionally, in this example, the display area 1008 may include data related to a second sensor (#0000403), which may include an error code (0F10), which may be indicative of a transceiver issue. The transceiver issue may include a lose connection, an incorrectly configured network connection, or other issues, such as a failed transceiver. Thus, the sensor dashboard provided within the GUI 1000 may be used by a technician to verify operation of the distributed radiation sensor devices 110.

In some implementations, error codes may cause the radiation mapping system 102 to generate an alert to one or more users who may be responsible for keeping the radiation sensor devices 110 in working condition. In response to receiving an alert, the user may attempt to diagnose and correct the issue.

While the error codes and brief descriptions are provided here for illustrative purposes, in some implementations, the codes and the descriptions may be more precise, enabling the user to readily determine the issue and to take remediation steps. In some implementations, the error codes and descriptions may include an identifier associated with the vehicle or location of the radiation sensor device, so that the user can quickly locate the radiation sensor device 110 for servicing. Other implementations are also possible.

In conjunction with the systems, methods, and devices described above with respect to FIGS. 1-10, a radiation measurement system is described that may include a plurality of radiation measurement devices 110. Each of the radiation measurement devices 110 may be deployed in order to capture radiation measurement data. Some of the radiation measurement devices 110 may be coupled to structures and may be configured to capture periodic measurements corresponding to a fixed area. Others of the radiation measurement devices 110 may be coupled to vehicles and may capture radiation measurement data over an area as the vehicle moves around.

In some implementations, spectral content of a radiation measurement for a location may be compared to spectral content of the background radiation data for the location to determine one or more differences. The differences may be compared to one or more spectral thresholds to determine an anomalous radiation measurement. The comparison may be performed by the radiation sensor device 110 or by the radiation mapping system 102, or both, depending on the implementation.

In an implementation where the radiation sensor device 110 is configured to determine anomalous radiation measurement data by comparing spectral content of a radiation measurement for a location to spectral content of background radiation for the measurement to determine differences and by comparing the differences to one or more spectral thresholds. Alternatively, or in addition, the radiation sensor device 110 may compare the spectral content of the radiation measurement data to spectral thresholds to determine anomalous radiation measurements when the spectral content exceeds at least one of the one or more spectral thresholds. In this example, the spectral threshold may represent an amplitude corresponding to the spectral content of the background radiation plus a delta value for each spectral frequency at the location.

In an implementation where the radiation mapping system 102 determines the anomalous radiation measurements, the radiation mapping system 102 may compare the spectral content of the radiation measurement data for a location to spectral content of the background radiation data for the location to determine anomalous measurements for the location. In some instances, the comparison may determine one or more differences, which may be compared to spectral thresholds to determine the anomalous radiation measurement. In other instances, the radiation mapping system 102 may compare the spectral content of the radiation measurement data for a location to spectral thresholds for the location. The spectral thresholds may represent an amplitude corresponding to the background radiation level plus a delta. Other implementations are also possible.

In some instances, the radiation sensor device 110 may send a periodic message to the radiation mapping system 102 that indicates a status of the radiation sensor device 110. When the radiation sensor device 110 has not detected an anomalous radiation measurement, the periodic message may provide an “all is well” message that indicates that the radiation sensor device 110 is operating and that no anomalous radiation measurements have been determined. The message may be sent according to a predetermined frequency, allowing the radiation mapping system 102 to have real-time status information. Such status information may include location data and status information, which may be a relatively small data footprint. Subsequently, such as when the radiation sensor device 110 is parked at a municipal depot or is otherwise in a resting state, the radiation sensor device 110 may establish a network connection and may send the correlated radiation measurement data (radiation measurement data correlated to location data and timestamp data) to the radiation mapping system 102.

Although the present invention has been described with reference to preferred embodiments, workers skilled in the art will recognize that changes may be made in form and detail without departing from the scope of the invention.

What is claimed is:

1. A radiation sensor device comprising
one or more sensors including at least one radiation sensor configured to capture radiation measurement data;
a location circuit configured to determine physical location data;
a clock configured to provide timestamp data; and
one or more communication interfaces configured to communicate with one or more computing devices through a communication network; and
a processor coupled to the one or more communication interfaces, the location circuit, the one or more sensors, and the clock, the processor configured to:
determine changes to the physical location data over time;
selectively control a frequency of operation of the one or more sensors to capture the radiation measurement data based the changes to the physical location data;
correlate the radiation measurement data to the physical location data and the timestamp;
determine an anomalous radiation measurement relative to background radiation data; and
in response to determining the anomalous radiation measurement, send an alert one or more computing devices through the communications network.

2. The radiation sensor device of claim 1, wherein the processor is configured to determine the anomalous radiation measurement by:
determining one or more differences between spectral content of the radiation measurement data for a location and spectral content of background radiation measurement data for the location; and
determining the anomalous radiation measurement when the one or more differences exceed at least one threshold.

3. The radiation sensor device of claim 2, wherein the processor determines a sensor error when the difference indicates that the radiation measurement data is less than the background radiation measurement by more than a second threshold.

4. The radiation sensor device of claim 1, wherein the processor is configured to:
determine a rate of change of the physical location data;
selectively control the frequency based on the rate of change to capture the radiation sensor measurement data each time the rate of change indicates that a physical location of the device has changed by a selected distance.

5. The radiation sensor device of claim 1, wherein:
the one or more sensors include a temperature sensor to provide a temperature measurement associated with the radiation sensor device; and
the processor is configured to determine one or more corrections to be applied to the radiation sensor measurement data based on the temperature.

6. The radiation sensor device of claim 1, wherein the processor is configured to:
determine the physical location data from the location circuit;
determine the physical location data corresponds to a parking depot;
send the correlated radiation measurement data to a radiation mapping server through the communication network using the one or more communications interfaces.

7. The radiation sensor device of claim 1, wherein, when the processor does not determine the anomalous radiation measurement for a period of time, the processor is configured to send a message to a radiation mapping server through one or more of the communication network or a communications link, the message including an indicator that no anomalous radiation measurement has been determined.

8. The device of claim 1, further comprising a rechargeable battery configured to receive a power supply from a vehicle during a measurement phase and to provide power to the communication circuit and the processor during a data communication phase.

9. A radiation sensor device comprising:
a clock to provide timestamp data;
one or more communication interfaces configured to communicate data to a radiation mapping system through one or more of a communication network or a communications link;
a plurality of sensors, the plurality of sensors including a radiation sensor to determine radiation measurement data;
a location circuit to determine physical location data associated with the radiation sensor device; and
a processor coupled to the one or more communications interfaces, the radiation sensor, and the location circuit, the processor configured to:
determine changes in the physical location data;
selectively control timing of measurements by the radiation sensor based on the changes;
correlate the radiation measurement data to the physical location data and the timestamp data;
determine one or more of a sensor error or an anomalous radiation measurement based on the radiation measurement data relative to background radiation data; and
send an alert to the one or more computing devices in response to determining the one or more of the sensor error or the anomalous radiation measurement.

10. The radiation sensor device of claim 10, wherein, when the processor does not determine the anomalous radiation measurement or the sensor error for a period of time, the processor is configured to send a message to a radiation mapping server through one or more of the communication network or a communications link, the message including an indicator that no anomalous radiation measurement has been determined.

11. The radiation sensor device of claim 9, wherein, to determine the sensor error or the radiation event, the processor is configured to:
determine one or more differences between spectral content of the radiation measurement data and spectral content of the background radiation data;
determine the anomalous radiation measurement when the one or more differences exceed one or more spectral thresholds; and
determine the sensor error when the difference is negative and the magnitude of the difference is greater than a second threshold.

12. The radiation sensor device of claim 9, wherein the processor is configured to:
determine a rate of change of the physical location data;
selectively control the frequency based on the rate of change to capture the radiation sensor measurement data each time the rate of change indicates that a physical location of the device has changed by a selected distance.

13. The radiation sensor device of claim 9, wherein:
the one or more sensors include a temperature sensor to provide a temperature measurement related to a temperature of the radiation sensor device; and
the processor is configured to apply one or more corrections the radiation sensor measurement data based on the temperature measurement.

14. The radiation sensor device of claim 9, wherein the processor is configured to determine the anomalous radiation measurement by:
determining one or more differences between spectral content of the radiation measurement data for a location and spectral content of background radiation measurement data for the location; and
determining the anomalous radiation measurement when the one or more differences exceed at least one threshold.

15. A radiation sensor device comprising:
a clock to provide timestamp data;
one or more communication interfaces configured to communicate data to a radiation mapping system through one or more of a communication network or a communications link;
a plurality of sensors, the plurality of sensors including one or more radiation sensors to determine radiation measurement data;
a location circuit to determine physical location data associated with the radiation sensor device; and
a processor coupled to the one or more communications interfaces, the one or more radiation sensors, and the location circuit, the processor configured to:
selectively control timing of measurements by the one or more radiation sensors based on changes in the physical location data;
correlate the radiation measurement data to the physical location data and the timestamp data;
determine one or more of a sensor error or an anomalous radiation measurement based on the radiation measurement data relative to background radiation data; and
send an alert to the radiation mapping system in response to determining the one or more of the sensor error or the anomalous radiation measurement.

16. The radiation sensor device of claim 15, wherein, to determine the sensor error or the anomalous radiation measurement, the processor is configured to:
determine differences between spectral content of the sensor measurement data and spectral content of the background radiation data;
determine the anomalous radiation measurement when one or more of the differences exceeds one or more spectral thresholds; and
determine the sensor error when the radiation measurement data is less than the background radiation data by more than a second threshold.

17. The radiation sensor device of claim 15, wherein the processor is configured to:
determine a rate of change of the physical location data;
selectively control the frequency based on the rate of change to capture the radiation sensor measurement data each time the rate of change indicates that a physical location of the device has changed by a selected distance.

18. The radiation sensor device of claim 15, wherein:
the one or more sensors include a temperature sensor to determine temperature data; and
the processor is configured to determine one or more corrections to be applied to the radiation sensor measurement data based on the temperature data.

19. The radiation sensor device of claim 15, wherein the processor is configured to:
determine the physical location data from the location circuit;
determine the physical location data corresponds to a parking depot; and
provide the correlated radiation measurement data to the radiation mapping server using the one or more communications interfaces.

20. The radiation sensor device of claim 15, wherein, when the processor does not determine the anomalous radiation measurement or the sensor error for a period of time, the processor is configured to send a message to a radiation mapping server through one or more of the communication network or a communications link, the message including an indicator that no anomalous radiation measurement has been determined.
